(19) United States
(12) Patent Application Publication
(10) Pub. No.: US 2008/0136202 A1
(43) Pub. Date: Jun. 12, 2008

(54) Scoop

(75) Inventors: Robert G. McRorie, Huntersville, NC (US); Jacob Connelly, Concord, NC (US)

Correspondence Address: LEMPIA BRAIDWOOD LLC, 223 W. JACKSON BLVD., SUITE 620, CHICAGO, IL, 60606, US

(73) Assignee: Rubbermaid Incorporated, Huntersville, NC (US)

(21) Appl. No.: 11/567,935

(22) Filed: Dec. 7, 2006

(51) Int. Cl. A01B 1/02

(52) U.S. Cl. 294/55

(57) ABSTRACT

A scoop includes an elongate side wall, a base, and a handle. The side wall extends generally along a longitudinal axis, and has a digging portion and a supporting portion that both extend circumferentially about the longitudinal axis such that the digging portion is circumferentially flatter than the supporting portion. The base extends between the digging portion and the supporting portion one outer end such that the base and the side wall at least partially define a receptacle having an access opening disposed at a second outer end. At least one of the digging portion and the supporting portion flares radially outwardly in a direction from the base toward the second outer end. The handle has a proximal end projecting outwardly from the supporting portion and an opposing distal end. The handle flares radially outward from the supporting portion in a direction from the proximal end toward the distal end.

### RELATED APPLICATION DATA

Not Applicable

### BACKGROUND

The present disclosure is generally directed to scoops of the type used for gathering and transporting quantities of bulk food product, and more particularly to such a scoop that is configured for efficient and/or sanitary use.

Scoops are well known for facilitating the retrieval and transfer of materials such as bulk foodstuff from one container to another. Some conventional scoops, such as measuring cups, have a known available volume and can be filled to transport a known quantity of material. Other conventional scoops, such as measuring cups, can be formed from a substantially cylindrical clear structure extending between the base and the open end to allow the user to visually approximate the amount of material being transferred.

Unfortunately, conventional scoops suffer from several drawbacks. For instance, scoops are suitable when retrieving material from a container having a large amount of material remaining, thereby allowing the user to retrieve the material from the container by actuating the scoop in a digging motion. However, if the volume of material remaining in the container is low, a user can experience difficulty retrieving the material using conventional scoops due to interference between the scoop and the base of the container.

Furthermore, most conventional scoops have a handle that projects radially outward from the open end of the scoops, and can have a tendency to either contact the material in the container or cause the user's hand to contact the material, particularly when the user does not maintain the handle in an upright orientation as the material is being retrieved. Furthermore, conventional scoops do not include any feature that suggests to the user that the handle is most properly oriented in a direction away from the contained material. Immersion of the handle into the contained material can contaminate the material particularly food product. This is particularly applicable to commercial kitchen applications.

What is therefore needed is a scoop having features that, either alone or in combination, provide for more reliable operation, more sanitary operation, and easier and more efficient storage capabilities.

### SUMMARY

In accordance with one aspect, a scoop includes an elongate side wall having a compressible digging portion and a supporting portion. The side wall defines first and second outer ends and a base extending between the digging portion and the supporting portion at the first outer end such that the base and the side wall at least partially define a receptacle having an access opening disposed at the second outer end. The scoop further includes a handle that projects outwardly from the supporting portion in a direction away from the digging portion. The handle extends from the supporting portion in a direction toward at least one of the outer ends.

In another aspect, a scoop includes a base, a side wall, and a handle projecting outwardly from the side wall. The side wall has a digging portion and a supporting portion, and extends from the base in a direction generally along a longitudinal axis. The digging portion and supporting portion extend circumferentially about the longitudinal axis such that the digging portion is circumferentially flatter than the supporting portion.

In yet another aspect, a scoop includes a base, a side wall, and a handle projecting from the side wall. The side wall extends from the base in a direction generally along a longitudinal axis. The side wall has a digging portion and a supporting portion. The side wall has an open outer longitudinal end that provides access to a receptacle that is at least partially defined by the base and the side wall. At least a portion of the side wall flares radially outward in a direction from the base to the open outer longitudinal end. The handle flares radially outward in a direction from the open outer longitudinal end toward the base.

In still another aspect, a scoop includes an elongate side wall, a base, and a handle. The side wall extends generally along a longitudinal axis. The side wall has first and second longitudinally outer ends, and a digging portion and a supporting portion. The digging portion and the supporting portion extending circumferentially about the longitudinal axis such that the digging portion is circumferentially flatter than the supporting portion. The base extends between the digging portion and the supporting portion at the first outer end such that the base and the side wall at least partially define a receptacle having an access opening disposed at the second outer end. At least one of the digging portion and the supporting portion flares radially outwardly in a direction from the base toward the second longitudinally outer end. The handle has a proximal end projecting outwardly from the supporting portion and an opposing distal end. The handle flares radially outward from the supporting portion in a direction from the proximal end toward the distal end.

It should be appreciated that the foregoing and other aspects of the invention will appear from the following description. In the description, reference is made to the accompanying drawings which form a part thereof, and in which there is shown by way of illustration, and not limitation, preferred embodiments of the invention. Such embodiments do not necessarily represent the full scope of the invention, and reference must therefore be made to the claims herein for interpreting the fill scope of the invention.

### BRIEF DESCRIPTION OF THE DRAWINGS

Objects, features, and advantages of the present invention will become apparent upon reading the following description in conjunction with the drawing figures in which like reference numerals are intended to represent like elements throughout, and in which:

FIG. 1 is a perspective view of a scoop constructed in accordance with one embodiment of the present invention;

FIG. 2 is a side elevation view of the scoop illustrated in FIG. 1;

FIG. 3 is a front elevation view of the scoop illustrated in FIG. 1;

FIG. 4 is a front elevation view of the scoop illustrated in FIG. 1;

FIG. 5 is a rear elevation view of the scoop illustrated in FIG. 1;

FIG. 6 is a perspective view of the scoop illustrated in FIG. 1 during use;

FIG. 7 is a another perspective view of the scoop illustrated in FIG. 1 during use; and

FIG. 8 is a sectional side elevation view of a pair of stacked scoops of the type illustrated in FIG. 1.

### DETAILED DESCRIPTION

A number of examples are disclosed herein of alternative scoops for retrieving and transferring materials, for example bulk foodstuff, from one container to another. The disclosed scoops solve or improve upon one or more of the problems or difficulties noted above with respect to conventional scoops. The disclosed alternative scoops are each generally formed from a body that includes a handle connected to a side wall. The side wall can be advantageously configured to retrieve contained material from the base of a container (for instance, when the remaining quantity of contained material is low). The handle can be advantageously configured to prevent contact between the handle (and user's hand) and the contained material during proper use. Moreover, the scoop contains features that allow a user to intuitively determine the proper use of the device. The disclosed scoop is further stackable with other like scoops, thereby conserving valuable space in, for instance, a commercial kitchen where the orderly and space-minimizing accessibility to the scoops is desirable.

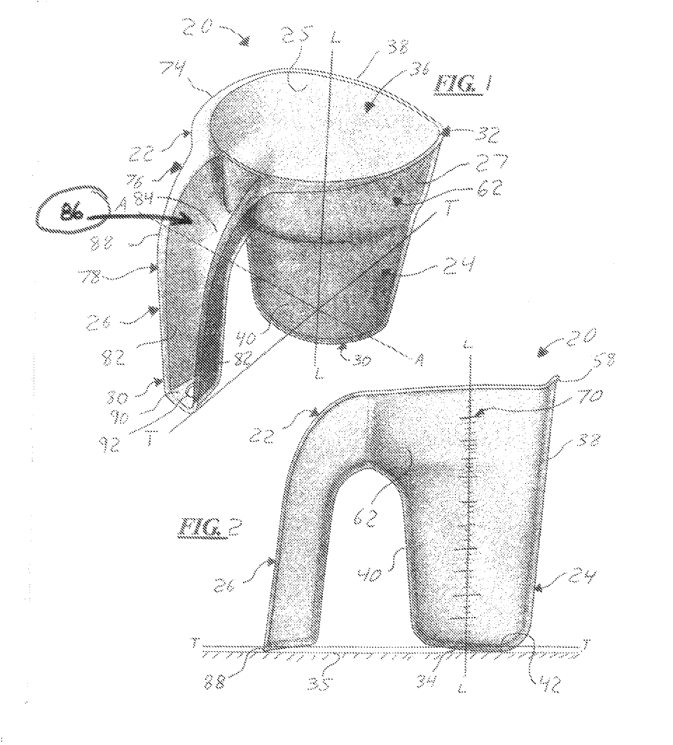

Turning now to the drawings, FIGS. 1 and 2 illustrate an exemplary scoop 20 constructed in accordance with one embodiment of the present invention. The scoop can be made from injection molded plastic, such as polycarbonate, polypropylene, Acrylonitrile Butadiene Styrene, or ABS, or any suitable alternative material and fabricated using any suitable alternative process as appreciated by one having ordinary skill in the art. The various components of the scoop 20 can be substantially transparent, translucent, or opaque, or can have two or more regions that differ in their levels of transparency.

The scoop 20 in this example generally includes a body 22 having a base 34, an elongate side wall 24, and a handle 26 projecting from the side wall. The body 22 defines a receptacle 36 that can receive, store, and deliver a desired material, such as a food product. When in a “storage” position, the scoop 20 is configured to stand upright such that the base 34 can rest on a support surface 35, such as a kitchen countertop or the like, and the side wall 24 extends upwardly from the base 34.

The side wall 24 extends generally along a central longitudinal axis L-L which extends generally perpendicular from the base 34 and is centrally disposed with respect to the side wall 24 that extends longitudinally outward from the base 34. The side wall 24 thus defines a longitudinally inner end 30 at the base 34 and an opposing longitudinally outer end 32 that provides access to the receptacle 36. The longitudinally outer end 32 defines the upper end of the scoop 20 when in the storage position. While it can be said that the side wall 24 extends circumferentially about the longitudinal axis L-L, certain components of the scoop 20 are described herein in more detail with reference to a transverse axis T-T that extends through the base 34 in a fore-aft direction substantially perpendicular to the longitudinal axis L-L, and/or a lateral axis A-A that extends laterally through the base 34 in a direction substantially perpendicular to the transverse and longitudinal axes.

Referring now to FIGS. 1-3, the base 34 extends generally along a plane that extends generally along the transverse and lateral axes T-T and A-A, respectively, across the longitudinally inner end 30 to provide a closed inner end 30 of the side wall 24. The longitudinal axis L-L extends centrally through the base.

The base 34 defines a front edge 42 and an opposing edge 44 that is connected at its outer ends to the front edge 42. The front edge 42 extends substantially laterally, and has a slight curvature about an axis extending parallel to the longitudinal axis L-L such that the front edge presents a concave surface that faces the longitudinal axis L-L. The opposing edge 44 spans across both the rear and the opposing lateral sides of the scoop 20, and defines a path that approximates the perimeter of a portion of an oval. Both edges 42 and 44 thus have a radius of curvature about a longitudinal axis L-L. As illustrated, the opposing edge 44 defines a radius of curvature that is smaller than that of the front edge 42, such that the curvature of the opposing edge is greater than that of the front edge 42.

The laterally outer ends of the front edge 42 of the base 34 is disposed longitudinally inward from the rearmost section of the edge 44 such that a plane extending from the outer ends of the front edge 42 to the center of the edge 44 is sloped with respect to a plane defined by the transverse and lateral axes T-T and A-A. The front edge 42 is curved between its laterally outer ends such that its inner (i.e., receptacle-facing) surface is convex. Alternatively, the front edge 42 could be linear or substantially linear between its outer ends, or assume any alternative suitable configuration. Likewise, the base 34 is contoured to enable the curvature of the front edge 42 as illustrated. Alternatively, the base 34 could be linear between the front edge 42 and the opposing edge 44. The contoured base 34 and front edge 42 ensures with even loose tolerances during manufacturing that the scoop 20 will rest on the outer ends of the front edge 42 when in its upright position, thus enhancing the stability of the scoop 20, as will be described in more detail below.

While the shape of the base 34 has been described and illustrated in accordance with one embodiment of the present invention, it should be easily appreciated that the base 34 and its various components could assume any one of numerous alternative geometric configurations (e.g., square, triangular, rectangular, circular, and the like) while allowing the base 34 to provide adequate structural support for the side wall 24 and closing the first end 30 of the side wall to partially define the receptacle 36.

Referring now to FIGS. 1-4, the scoop 20 defines an interior receptacle 36 that is bound at its inner end and its sides by the base 34 and the side wall 24, respectively, and has an access opening defined by the longitudinal outer end 32 that facilitates insertion and removal of a material in and out of the receptacle 36. The side wall 24 extends longitudinally outward from the base 34, and defines a front end providing a digging portion 38 that is configured to engage contents of a canister in a scooping portion to deliver the contents to the receptacle 36, and a rear end providing a supporting portion 40 that is integrally connected at its circumferential outer ends to the digging portion 38 and provides structural support for the digging portion 38 and the remainder of the scoop 20. The side wall 24 thus defines an inner, receptacle-facing, surface 25 and an opposing outer surface 27. The side wall 24 is substantially symmetrical with respect to both a plane defined by the longitudinal axis L-L and the lateral axis A-A, and a plane defined by the longitudinal axis L-L and the transverse axis T-T.

The digging portion 38 defines a generally rectangular body that extends generally along a plane defined by a longitudinal axis L-L′ and a lateral axis A-A′. The longitudinal axis L-L′ extends centrally through the digging portion 38 in a direction substantially parallel to longitudinal axis L-L. The lateral axis A-A′ extends centrally through digging portion 38 in a direction substantially parallel to the lateral axis A-A. It should be appreciated that the term “substantially parallel” refers to a direction that may be slightly angled with respect to the reference axis depending on, for instance, the orientation of the digging portion 38 or base 34.

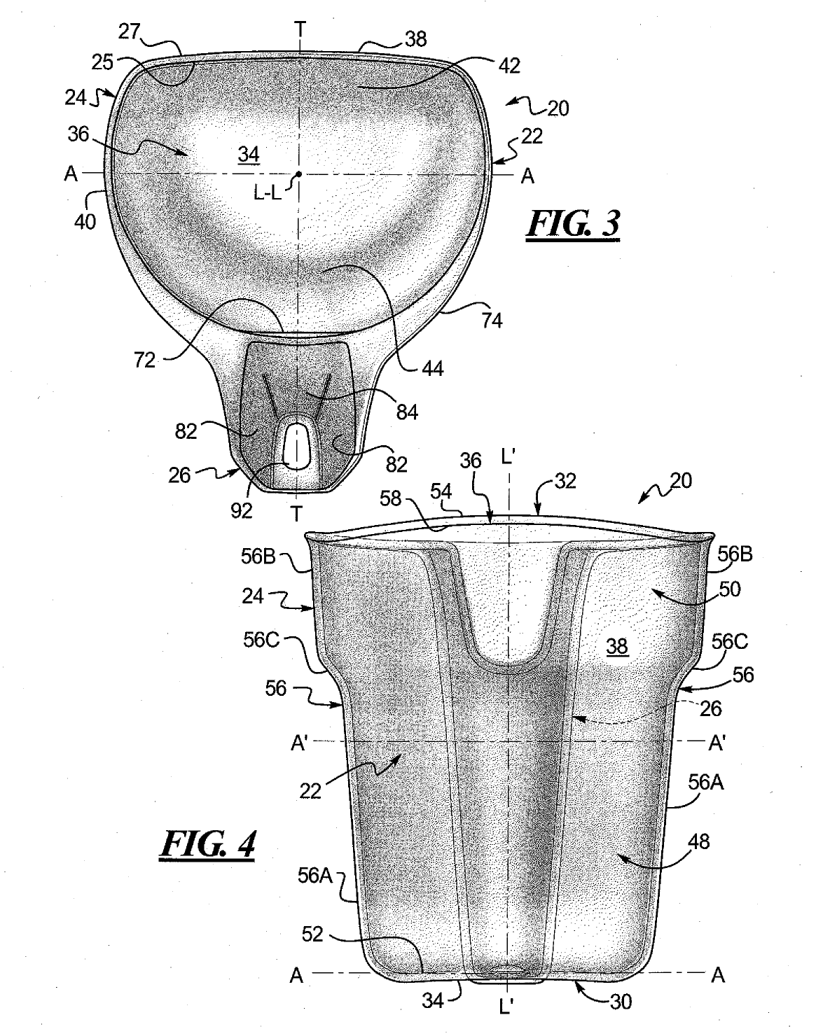

As illustrated in FIG. 3, the digging portion 38 is slightly curved about a longitudinal axis (not shown) that extends parallel to the longitudinal axis L-L′. The curvature of the digging portion 38 is sufficiently slight such that the digging portion 38 can be said to be substantially flat, or to extend generally along the plane defined by the longitudinal axis L-L′ and the lateral axis A-A′. However, because the digging portion 38 is curved, it can be said to extend circumferentially about the longitudinal axis L-L. One skilled in the art will appreciate that the digging portion 38 could alternatively comprise a flat body, or could be curved about more than one longitudinal or lateral axis if, for instance, the digging portion 38 were to include regions of different curvature. The term “substantially flat” when used in combination with the digging portion 38 is thus intended to encompass both a flat body and a body having a curvature that can be at least partially flattened during use, as will be described in more detail below.

Referring now to FIG. 4, the digging portion 38 is bound by a longitudinally inner edge 52 that is integrally connected to the front edge 42 of the base 34, an opposing longitudinally outer edge 54, and a pair of opposing side edges 56 that extend between the inner edge 52 and the outer edge 54. The digging portion 38 includes a longitudinally inner region 48 that is connected to the base 34 and a longitudinally outer region 50 that is disposed longitudinally outward from, and integrally connected to, the inner region 48. The longitudinally inner region 48 and longitudinally outer region 50 are substantially rectangular as illustrated. The side edges 56 are defined by edge segments 56A corresponding to the opposing side edges of the inner region 48, and edge segments 56B corresponding to the opposing side edges of the outer region 50.

The opposing inner edge segments 56A each flare laterally outwardly from the inner edge 52 linearly as the longitudinal distance from the inner edge 52 increases. The outer edge segments 56B are offset from the inner edge segments 56A such that the inner end of the edge segments 56B are disposed laterally outward with respect to the outer end of edge segments 56A. Transition segments 56C flare laterally outward from the longitudinally outer end of inner edge segments 56A and connect to the longitudinally inner end of the outer edge segments 56B. The edge segments 56B also flare laterally outwardly from the transition segments 56C linearly such that they extend in a direction substantially parallel to the edge segments 56A. The edge segments 56B terminate at the longitudinally outer end 54 of the digging portion 38.

Referring now to FIGS. 2 and 4, the longitudinally outer end 54 projects transversely outwardly from the outer region 50 to provide a lip 58. The lip 58 has a convex outer surface such that its central portion is disposed longitudinally outward from its lateral outer ends. The contour of the lip 58 tapers to a substantially flat section immediately adjacent its lateral outer ends. The lip 58 is thus advantageously configured to scrape against canister surfaces when, for instance, it is desired to remove a remaining quantity of material from the canister as will be described in more detail below. The digging portion 38 can be rendered flexible based on at least one of its thickness or material to assist in scraping, as will be described in more detail below.

It should be appreciated, of course, that the geometric configuration of the digging portion 38 is just one of numerous configurations that would be suitable in accordance with various aspects of the present invention. For instance, while the digging portion 38 approximates the shape of a rectangle as illustrated, the digging portion 38 could alternatively comprise any suitable geometric shape, such as a square, pure rectangle, frustotriangular, round shape such as an oval, and the like.

Referring now to FIGS. 1-3 and 5, the supporting portion 40 is substantially curved about a longitudinal axis (not shown) and can thus be said to extend circumferentially about the longitudinal axis L-L. It should be appreciated that the supporting portion 40 could alternatively extend about more than one longitudinal axis if, for instance, the supporting portion 40 has regions of different curvature. As illustrated, the supporting portion 40 defines a radius of curvature less than that of the digging portion 38, such that the curvature of the supporting portion 40 is greater than the curvature of the digging portion 38.

It should be appreciated that the supporting portion 40 connects to the digging portion 38 which defines the front of the scoop 20. The supporting portion 40 thus defines the rear of the scoop 20 as well as the opposing side regions of the scoop 20. While the scoop 20 therefore does not include discreet side portions disposed between the front and the rear ends of the scoop 20, one having ordinary skill in the art will recognize that the scoop 20 could assume one of numerous alternative configurations, including configurations whereby the supporting portion 40 does not extend continuously from the rear to the front of the scoop 20, but rather the scoop includes one or more side regions connected either integrally or discretely between the front and rear of the scoop 20.

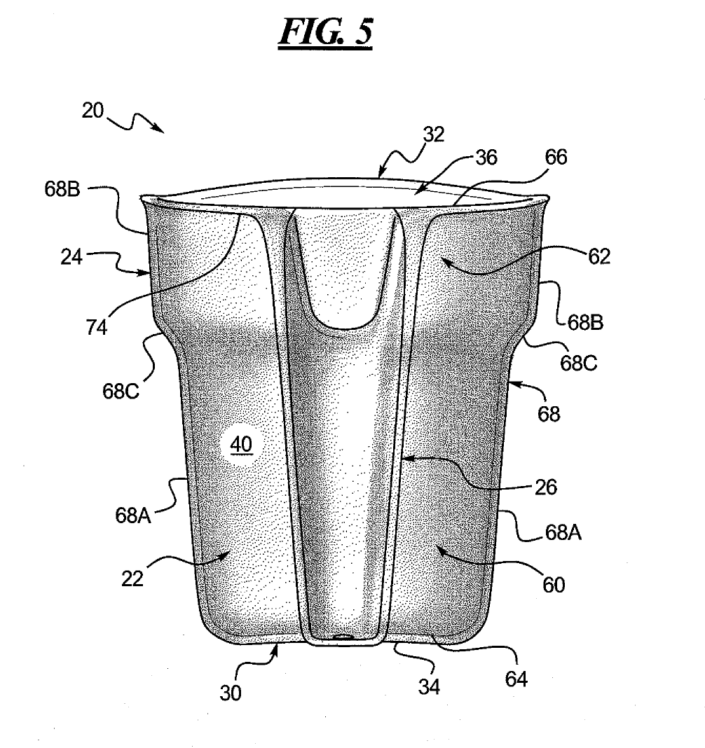

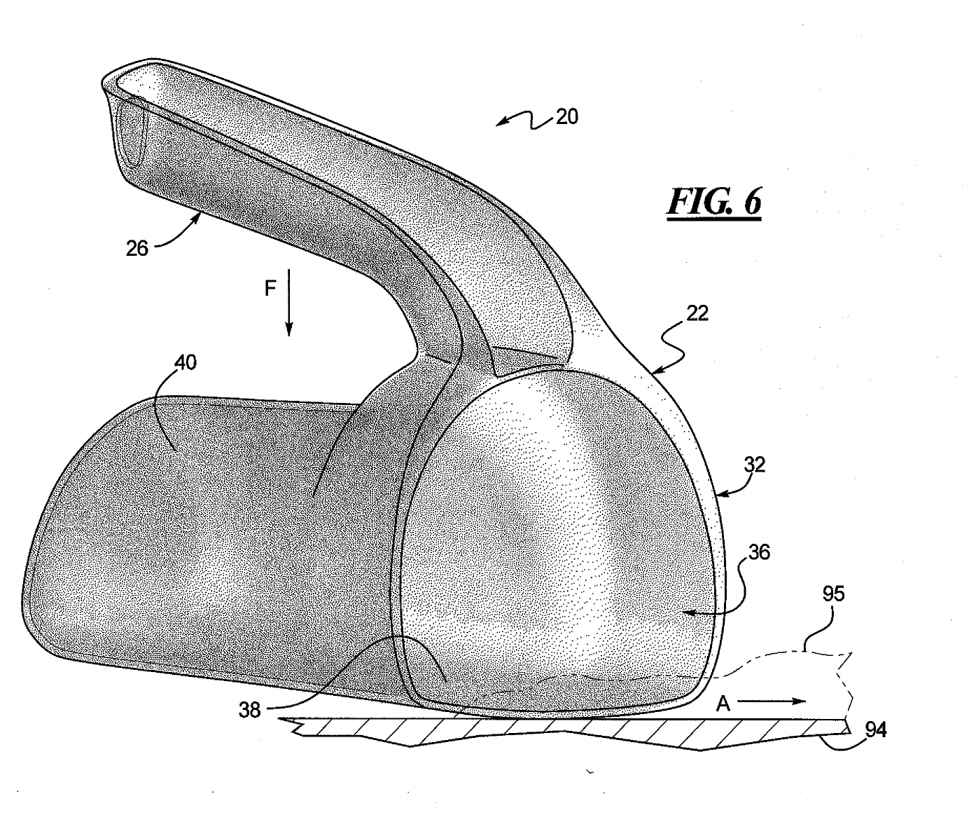

Referring now to FIG. 5 in particular, the supporting portion 40 is bound by a longitudinal inner edge 64 that is integrally connected to the opposing edge 44 of the base 34, and opposing longitudinally outer edge 66, and a pair of opposing circumferential end edges 68 that extend between the inner edge 64 and the outer edge 66. The supporting portion 40 includes a longitudinally inner region 60 that is connected to the base 34 and a longitudinally outer region 62 that defines a rim which is disposed longitudinally outward from, and integrally connected to, the inner region 60. The circumferential end edges 68 are defined by opposing inner edge segments 68A corresponding to the longitudinally inner region 60, and outer edge segments 68B corresponding to the rim 62. The longitudinally inner region 60 is aligned with, and connected to, the longitudinally inner region 48 of the digging portion 38, and the longitudinally outer region 62 is aligned with, and connected to, the longitudinally outer region 50 of the digging portion 38. Accordingly, the circumferential end edge segments 68A-B are connected to the edge segments 56A-B, respectively, of the digging portion 38.

The supporting portion 40 does not extend perfectly longitudinally, but rather flares radially outwardly in a direction longitudinally outward from the base 34. Specifically, the opposing inner edge segments 68A each flare laterally outwardly from the inner edge 64 linearly as the longitudinal distance from the inner edge 64 increases. The outer edge segments 68B are offset from the inner edge segments 68A such that the inner end of the edge segments 68B are disposed laterally outward with respect to the edge segments 68A. Transition segments 68C flare radially outward from the longitudinally outer end of the inner edge segments 68A and connect to the longitudinally inner end of the outer edge segments 68B. The edge segments 68B also flare laterally outwardly from the transition segments 68C linearly such that they extend in a direction substantially parallel to the edge segments 68A. The edge segments 68B terminate at the longitudinally outer end 66 of the supporting portion 40.

Though both the digging portion 38 and the supporting portion 40 slightly diverge in a direction of longitudinally outward travel from the base 34, it can nevertheless be said that the side wall 24 extends generally along the longitudinal axis L-L. It should be appreciated, in accordance with certain aspects of the invention, that the side wall 24 could alternatively extend substantially or perfectly longitudinally outwardly from the base 34.

Referring now to FIG. 2, typical measurement markings 70 can also be integrated into the supporting portion 40. In particular, the markings can be present on one or both laterally opposing regions of the supporting portion in order to assist the user in visually determining the quantity of material present in the receptacle 36. One skilled in the art will appreciate that the markings 70 can alternatively be provided any suitable location either on the supporting portion 38 and/or the digging portion 40.

As illustrated in FIG. 3, the scoop 20 includes one or more features that provides structural support and absorbs various load forces that are applied to the scoop 20 during use. For instance, a strengthening spine 72 extends longitudinally between the inner edge 64 and the outer edge 66 of the supporting portion 40. The spine 72 is substantially circumferentially centered with respect to the end edges 68. The spine 72 can comprise a discrete support structure that is joined to the receptacle-facing surface of the supporting portion 40, or as illustrated can comprise a region of increased material. Additionally, a flange 74 projects radially outwardly from the outer edge 66 of the supporting portion 40. Specifically, the flange 74 projects between the opposing edge segments 68C, and has a radial length that increases in a circumferential direction from the edge segments 68C towards the spine 72, such that its radial length is the longest immediately adjacent the spine 72.

The handle 26 will now be described with reference to FIGS. 1-3. The handle can be integrally connected to the supporting portion 40, or alternatively can be discretely attached to the supporting portion 40 using any known attachment mechanism appreciated to one having ordinary skill in the art.

The handle 26 defines a proximal segment 76 that connected to the supporting portion 40, a middle segment 78 disposed downstream from the proximal segment 76, and a distal segment 80 disposed downstream from the middle segment 78. The proximal segment 76 of the handle 26 projects substantially radially outwardly from the rim 62 of the supporting portion 40 at a location substantially aligned with the strengthening spine 72. The distal end of the proximal segment 76 curves longitudinally inwardly towards the middle segment 78. The middle segment 78 curves further longitudinally inwardly, and slightly radially outwardly, from the proximal segment 76. The distal segment 80 extends substantially linearly from the middle segment 78. Specifically, the distal segment 80 extends substantially longitudinally inwardly and less slightly radially outwardly than the middle segment 78.

The distal segment 80 terminates at a location spaced transversely from the side wall 24 and in substantial longitudinal alignment with the front edge 42 of the base 34. A cap 90 extends across the longitudinally inner edges of the side walls 82 to close the distal end 80 of the handle 26. The cap 90 is sloped with respect to a plane defined by the transverse and lateral axes T-T and A-A, respectively such that the rear end of the cap 90 is disposed longitudinally outward with respect to the front end of the cap 90. Accordingly, when the scoop 20 is in its upright position, the scoop 20 rests on a substantially triangular support provided by the rear end of the cap 90 and the laterally outer ends of the front edge 42 of the base 34. An aperture 92 extends longitudinally through the cap 90 and is configured to receive a hook or the like to facilitate hanging of the scoop 20 as desired.

While the digging portion 38, the supporting portion 40, the base 34, and the handle 26 are integrally connected to each other, it should be appreciated that they could instead be mechanically connected to each other using any known method. Furthermore, the base 34, the digging portion 38, the supporting portion 40, and the handle 26 need not individually be integral members, but instead may each comprise one or more members that are mechanically connected to each other using any known method.

The handle 26, like the side wall 24, includes one or more features that provides structural support and absorbs various load forces that are applied to the scoop 20 during use. For instance, as most clearly shown in FIGS. 1 and 3, the handle 26 defines a substantially “U-shaped” body formed from a pair of opposing side walls 82 that are joined by a rounded recessed surface 84. The side walls 82 and recessed surface 84 extend continuously from the rim 62 and through the proximal segment 76, the middle segment 78, and the distal segment 80. In addition to absorbing loads that are imparted onto the handle 26 during use, the U-shaped structure advantageously defines a concave surface that faces outwardly (i.e., in a direction facing away from the receptacle 36) to provide a groove 86 that is configured to ergonomically receive a user's thumb while the user's remaining fingers can grasp the convex underside of the handle 26 during operation.

Additionally, a flange 88 projects substantially perpendicularly out from the side walls 82 of the handle 26. The flange 88 projects between the distal end of the distal segment 80 and the flange 74 of the supporting portion 40. The length of the flange 88 increases in a direction towards the flange 74. It should thus be appreciated that flanges 74 and 88 provide structural integrity to the scoop 20 that absorbs forces imparted to the handle 26 during use. The flange 88 can further project longitudinally inwardly from the distal end of the rear edge of the cap 90 as illustrated such that, when the scoop 20 is resting on the support surface 35 in its upright position, the opposing laterally outer ends of the front edge 42 of base 34 and the flange 88 extending from the cap 90 are in direct contact with the support surface 35 to form a stable triangular support.

While the scoop 20 is a unitary molded body as described herein in accordance with one embodiment of the present invention, it should be appreciated that the base 34, the digging portion 38, the supporting portion 40, and the handle 26 and their components could alternatively be connected via any suitable fastener or indirectly connected via interposed structure. For example, one skilled in the art will appreciate that the scoop 20 could include discrete side walls connected between the digging portion 38 and the supporting portion 40. For the purposes of this disclosure, the term “connected” is not limited to integral connection, mechanical connection, or indirect connection unless otherwise specified.

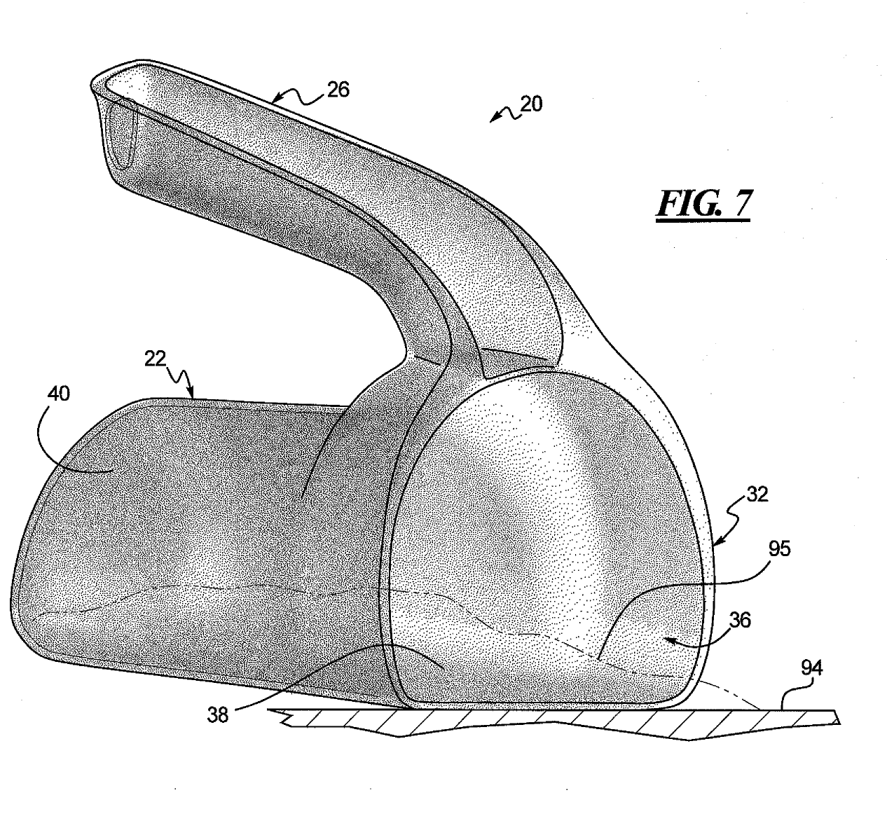

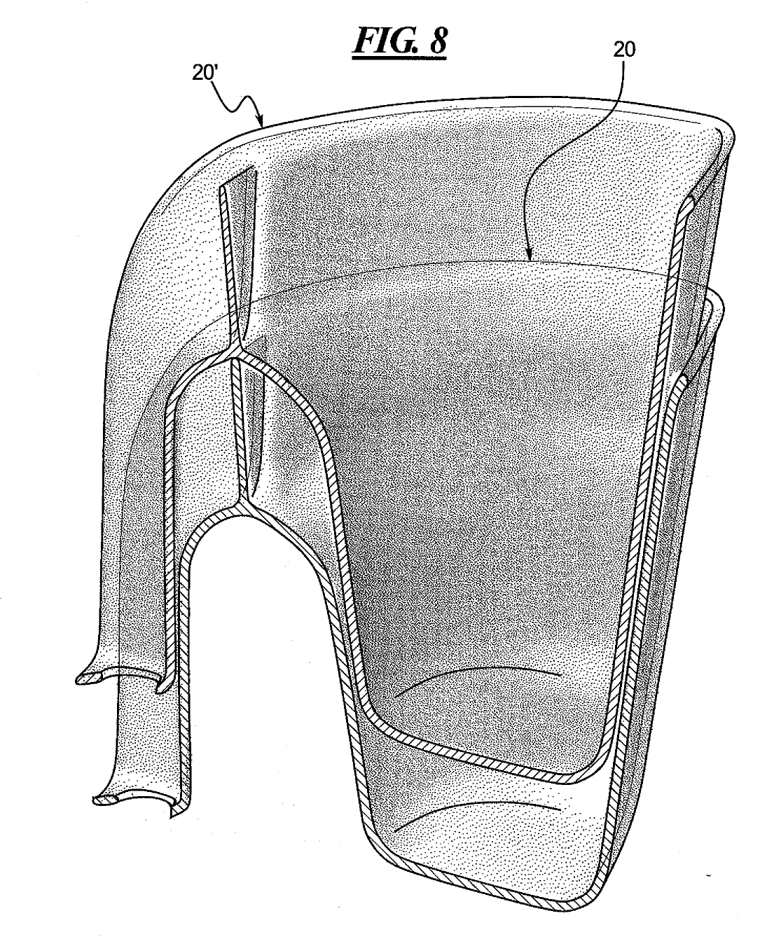

The operation of the scoop 20 will now be described with reference to FIGS. 6 and 7. As described above, the scoop 20 can rest on a substantially flat support surface 35 such that the scoop rests on the base 20 and the handle 26, and the open longitudinal end 32 defines an upper end. Accordingly, unintentionally spillage of material from the receptacle 36 can be prevented. However, when one wishes to empty the receptacle 36, the user can grab the handle 26 and tilt the scoop in the usual manner to pour the material out the receptacle 26 to a desired destination.

When a user desires to remove a quantity of material 95 from, for instance, a canister 94, the user can grasp the handle 26 in the manner described above, and direct the open longitudinal end 32 into the canister 94 such that the digging portion 38 is at least partially submerged in the material 95 to be removed such that the scoop 20 can be actuated along the direction of Arrow A in a scooping motion to entrap the desired material 95 in the receptacle 36.

The scoop 20 is particularly suitable for removing a remaining quantity of material from the canister 94 that may, for instance, be adhered to (or located in close proximity with) a canister surface 94. Specifically, because the lip 58 of the digging portion 38 is flexible and has a curvature about a longitudinal axis as described above, when the lip 58 first engages the canister surface 94, only a portion of the lip 58 engages the surface as shown in FIG. 6. The user gripping the handle 26 can thus apply pressure (e.g., downward pressure) to the scoop 20 in the direction of Arrow F, thereby causing the lip 58 to flatten against the canister surface 94 such that substantially the entire lip 58 engages the surface 94 under the user-applied pressure as shown in FIG. 7. As described above, so long as at least a portion of the lip 58 or other material-engaging structure of the digging portion 38 can flatten against the canister surface 94, the structure can be said to be “substantially flat” as used herein. Accordingly, as the user translates the scoop 20 in the longitudinal direction indicated by Arrow A, the lip 58 of the digging portion 38 can forcibly scrape the material 95 from the canister surface 94 and thus cause the material to enter the receptacle 36.

Advantageously, because the handle 26 extends radially outward from the rearmost section of the supporting portion 40, the handle 26 extends in a direction directly away from the digging portion 38. Accordingly, during use, as a user grasps the handle 26 to scoop the material 95 from the canister 94, the user's hand will not be brought into contact with the material 95 (often a food product) during normal use of the scoop 20. Advantageously, the substantially flat digging portion 38 together with the position and orientation of the handle 26 suggest an intuitive use to the user, thereby increasing the likelihood that the scoop will be actuated in such a manner with the handle 26 extending away from the material 95 being scooped. The scoop 20 is thus configured to minimize the risk of possible contamination of the material 95.

Referring now to FIG. 8, the scoop 20 is advantageously geometrically configured to be stackable with other like scoops 20′. Specifically, the angle that the side wall 24 presents with respect to the longitudinal axis L-L enables the side wall of like scoops 20′ to nest within the side wall 24 of scoop 20. Likewise, the angle that the handle 26 presents with respect to the longitudinal axis L-L, coupled with the concave U-shaped profile, allows handles of like scoops 20′ to nest within the handle 26 of scoop 20. Accordingly, a plurality of scoops can be stacked upon a first scoop 20 that is, for instance, disposed in its upright orientation on the support surface 35 which can be, for instance, a store shelf for point-of-sale purchasing, or shelving of a commercial kitchen. The stacking feature of the scoop 20 allows multiple scoops to be stored for space conservation and easy accessibility.

The invention has been described in connection with what are presently considered to be the most practical and preferred embodiments. However, the present invention has been presented by way of illustration and is not intended to be limited to the disclosed embodiments. For instance, as discussed above, numerous geometric configurations of the various components of the scoop 20 are available without departing from one or more of the advantages achieved by the present invention. Accordingly, those skilled in the art will realize that the invention is intended to encompass all modifications and alternative arrangements included within the spirit and scope of the invention, as set forth by the appended claims.

1-20. (canceled)

21. A scoop comprising:
a base;
a sidewall extending from the base along a longitudinal axis and terminating at an outer end, the sidewall and base forming a receptacle having an access opening at the outer end, the sidewall including a front portion having opposed longitudinal side edges and a supporting portion integrally connected to the side edges of the front portion, wherein the front portion has a radius of curvature about the longitudinal axis and the supporting portion has a radius of curvature about the longitudinal axis that is less than the radius of curvature of the front portion, and
a handle projecting radially outwardly from the supporting portion in a direction away from the front portion and toward the base.

22. The scoop as recited in claim 21, wherein the base rests on a support surface when the scoop is in a storage position so that the sidewall extends generally vertically upward from the base and the front portion lies within a substantially vertical plane.

23. The scoop as recited in claim 21, wherein the front portion includes a flexible lip at the outer end.

24. The scoop as recited in claim 23, wherein the flexible lip extends longitudinally outward past the outer end of the supporting portion.

25. The scoop as recited in claim 23, wherein the flexible lip extends from the outer end at a first side edge longitudinally outward to a center location and then longitudinally inward to a second side edge, so that the flexible lip has a substantially smooth convex shape.

26. The scoop as recited in claim 21, wherein the handle has a distal end that is substantially in alignment with the base.

27. The scoop as recited in claim 21, wherein the supporting portion includes an inner segment extending longitudinally from the base and an outer segment adjacent the outer end and disposed radially outward from the inner segment, wherein the inner segment and the out segment are integrally joined by a transition segment.

28. The scoop as recited in claim 27, wherein the handle has opposed sidewalls joined by a rounded surface forming a closed side and being open at an opposite side to form an open U-shaped profile, the handle integrally connected at a proximal end to the supporting portion near the outer end and extending radially outward toward the base to a distal end.

29. The scoop as recited in claim 28, wherein the scoop is one of plural scoops including a first scoop and a second scoop, the first and second scoops being substantially identical, wherein the supporting portion is radially angled from the front portion so that the outer segment of the first scoop is configured to receive a portion of the sidewall of the second scoop and the open side of the handle of the first scoop is configured to receive a closed side of a handle of the second scoop so that the first and second scoops are stackable in a nested configuration.

30. A scoop comprising:
a base;
a sidewall extending from the base along a longitudinal axis and terminating at an outer end, the sidewall and base forming a receptacle having an access opening at the outer end, the sidewall including a front portion and a supporting portion integrally connected to the front portion, wherein the supporting portion has a radius of curvature about the longitudinal axis and the front portion is substantially flat, and
a handle connected to The supporting portion near the outer end and extending toward the base.

31. The scoop as recited in claim 30, wherein the front portion has a flexible lip That extends longitudinally outward from The outer end of the supporting portion.

32. The scoop as recited in claim 31, wherein the flexible lip has a substantially smooth convex shape.

33. The scoop as recited in claim 30, wherein The supporting portion includes an inner segment extending longitudinally from the base and an outer segment adjacent the outer end and disposed radially outward from the inner segment, wherein the inner segment and the out segment are integrally joined by a transition segment.

34. The scoop as recited in claim 33, wherein the front portion is wider near the outer end than at The base.

35. The scoop as recited in claim 33, wherein the front portion includes opposed side edges, each side edge including an inner edge integrally connected to the inner segment of the supporting portion and flaring outward to an outer side edge integrally connected to the outer segment of the supporting segment.

36. The scoop as recited in claim 30, wherein the base has a front edge integrally connected to the front portion at a first longitudinal location and an opposed rear edge integrally connected to the supporting portion at a second longitudinal location, the second longitudinal location being closer to the outer end than the first longitudinal location so that the base slopes longitudinally from the rear edge to the front edge.

37. The scoop as recited in claim 36, wherein the handle has a distal end with a bottom face having a first radially inner end and slopes longitudinally to a second radially outer end, wherein the scoop is supported by the front edge of the base and the second radially outer end of the handle when in the storage position.

38. The scoop as recited in claim 30, wherein the handle has opposed sidewalls joined by a rounded surface forming a closed side and being open at an opposite side to form an open U-shaped profile, the handle integrally connected at a proximal end to the supporting portion near the outer end and extending radially outward toward the base to a distal end.

39. The scoop as recited in claim 38, wherein the scoop is one of plural scoops including a first scoop and a second scoop, the first and second scoops being substantially identical, wherein the supporting portion is radially angled from the front portion so that the outer segment of the first scoop is configured to receive a portion of the sidewall of the second scoop and the open side of the handle of the first scoop is configured to receive a closed side of a handle of the second scoop so that the first and second scoops are stackable in a nested configuration.
